(19) United States
(12) Patent Application Publication
(10) Pub. No.: US 2019/0376813 A1
(43) Pub. Date: Dec. 12, 2019

(54) CLOUD METERING AND ANALYZING SYSTEM

(71) Applicant: DAE AUTOMATION CORP., New Taipei City (TW)

(72) Inventors: Chin-Lung Weng, NEW TAIPEI CITY (TW); Wen-Sung Chu, NEW TAIPEI CITY (TW)

(21) Appl. No.: 16/531,062

(22) Filed: Aug. 3, 2019

Related U.S. Application Data
(63) Continuation-in-part of application No. 15/598,273, filed on May 17, 2017.

(51) Int. Cl. G01D 4/00; H04L 12/66

(52) U.S. Cl. CPC G01D 4/002; H04L 12/66

(57) ABSTRACT

A cloud metering and analyzing system is provided. The cloud metering and analyzing system of the present invention includes an automatic-meter-reading module, at least one gateway device, and a cloud server. The automatic-meter-reading module is directly connected to at least one terminal meter having no communication function to collect at least one measurement value from the at least one terminal meter. The at least one gateway device is connected to the automatic-meter-reading module to receive and transmit the at least one measurement value. The cloud server is connected to the at least one gateway device to receive and store the at least one measurement value from the at least one gateway device in real time and automatically produce an analysis report according to the at least one measurement value.

### CROSS-REFERENCE TO RELATED APPLICATIONS

This application is a continuation-in-part (CIP) application of U.S. patent application Ser. No. 15/598,273, filed on May 17, 2017.

### BACKGROUND OF THE INVENTION

### 1. Field of the Invention

The present invention relates to a metering and analyzing system, and more particularly to a cloud metering and analyzing system.

### 2. Description of Related Art

Energy, such as electricity, water, or gas, is important for daily life. A landlord or a property management company may handle housing for many renters or clients. The landlord or the property management company has to understand the electricity consumption, water consumption, or gas consumption of the renters or the clients periodically. For example, for a landlord, a conventional method to understand the electricity consumption of a renter is to go to the place of the renter, check the power meter, and manually record the power consumption displayed on the power meter on a sheet of paper or paper notebook.

However, the original hard copy that contains the record belongs to and is kept by the landlord only. For the renter, the only chance to review this record is to request the landlord to provide it. Hence, the renter fails to review the physical record anytime and anywhere. Besides, the renter may manually record the electricity consumption by himself/herself. However, the electricity consumptions recorded by the landlord and the renter may be inconsistent, so disputes between the landlord and the renter occur.

### SUMMARY OF THE INVENTION

An objective of the present invention is to provide a cloud metering and analyzing system to overcome the problem as mentioned in the descriptions of the related art.

The cloud metering and analyzing system of the present invention comprises an automatic-meter-reading module, at least one gateway device, and a cloud server. The automatic-meter-reading module is directly connected to at least one terminal meter having no communication function to collect at least one measurement value from the at least one terminal meter. The at least one terminal meter is at least one digital meter. The at least one gateway device is connected to the automatic-meter-reading module to receive and transmit the at least one measurement value. The cloud server is connected to the at least one gateway device to receive and store the at least one measurement value from the at least one gateway device in real time and automatically produce an analysis report according to the at least one measurement value.

In conclusion, the automatic-meter-reading module is adapted to interface between the at least one gateway device and the at least one terminal meter without communication capability, such that the at least one measurement value may be outputted to the cloud server from the at least one terminal meter through the automatic-meter-reading module and the at least one gateway device. The cloud server may display the measurement values in the analysis report. The renter and the landlord may use their user devices (such as a personal computer, a notebook computer, or a smart device) to communicate with the cloud server to monitor, check, and review the analysis report. The information reviewed by the renter and the landlord is identical, so disputes between the landlord and the renter may be avoided. The problem as mentioned in the descriptions of the related art is thus overcome.

In addition, the cloud server of the present invention not only displays the at least one measurement value, but also produces the analysis report. By reviewing the analysis report, the renter may understand his/her utility consumption behavior and accordingly adjust the behavior to conserve the energy such as electricity, water, or gas.

### BRIEF DESCRIPTION OF THE DRAWINGS

FIG. 1 is a block diagram of a first embodiment of the present invention;

FIG. 2 is a block diagram of a second embodiment of the present invention;

FIG. 3 is a block diagram of a third embodiment of the present invention;

FIG. 4 is a block diagram of a fourth embodiment of the present invention;

FIG. 5 is a block diagram of the administrator account and the terminal accounts created in the cloud server of the present invention;

FIG. 6 is a block diagram of an embodiment that the cloud server remotely controls the relay and the solenoid valve;

FIG. 7 is a block diagram of the cloud server to produce the analysis report according to the measurement values;

FIG. 8 is a consumption diagram of water usage behavior in a day;

FIG. 9 is a block diagram of the cloud server to produce the analysis report as a warning report to the user device;

FIG. 10 is a flow chart of the cloud server for determining whether a trigger condition occurs; and

FIG. 11 is a real-time consumption diagram of water usage behavior.

### DETAILED DESCRIPTION OF THE PREFERRED EMBODIMENT

The cloud metering and analyzing system of the present invention comprises at least one terminal meter, at least one gateway device, and a cloud server. The at least one terminal meter may be at least one digital meter. For example, the terminal meter may be, but not limited to, a digital power meter, a digital water meter, or a digital gas meter. The terminal meter may have communication function or have no communication function. The terminal meter having communication function may be connected to and communicate with a network device, such as a gateway device. The terminal meter having no communication function is incapable of communicating with the network device.

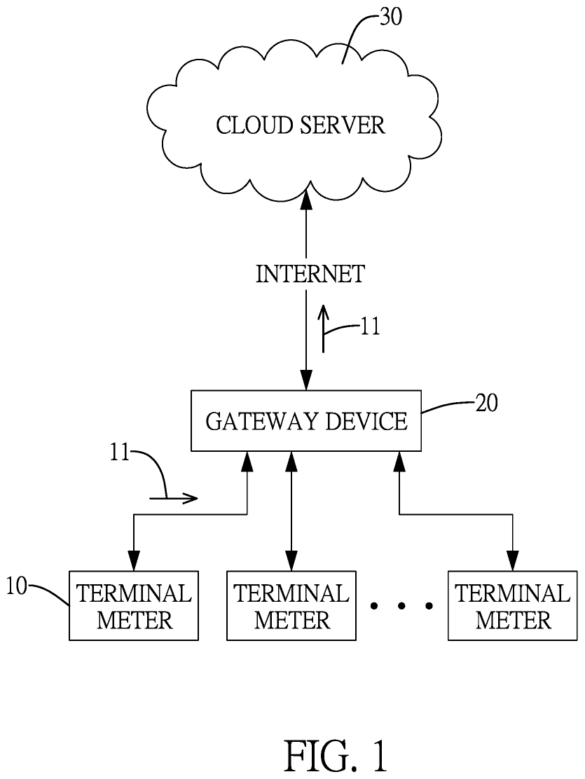

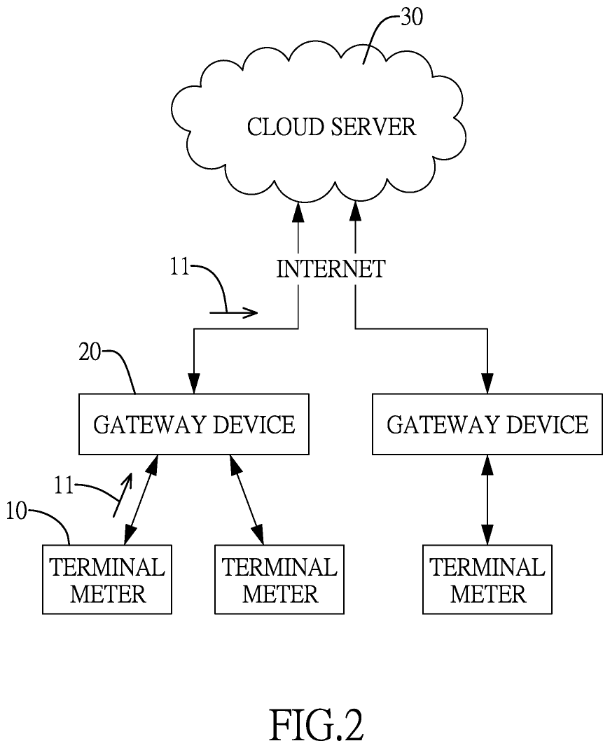

With reference to FIG. 1, an embodiment of the cloud metering and analyzing system of the present invention may comprise multiple terminal meters 10, a gateway device 20, and a cloud server 30. Besides, the at least one gateway device in another embodiment of the present invention shown in FIG. 2 may include multiple gateway devices 20. As shown in FIG. 1 and FIG. 2, the gateway device 20 may be connected to one or more than one terminal meter 10. The multiple terminal meters 10 connected to one gateway device 20 may include same kind of meter or different kinds of meters. Different gateway devices 20 in FIG. 2 may be connected to different terminal meters 10.

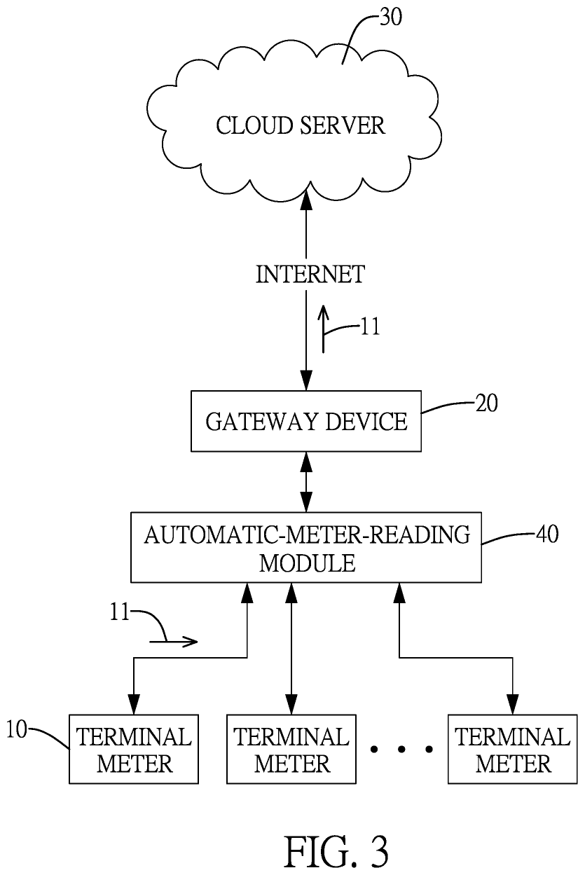

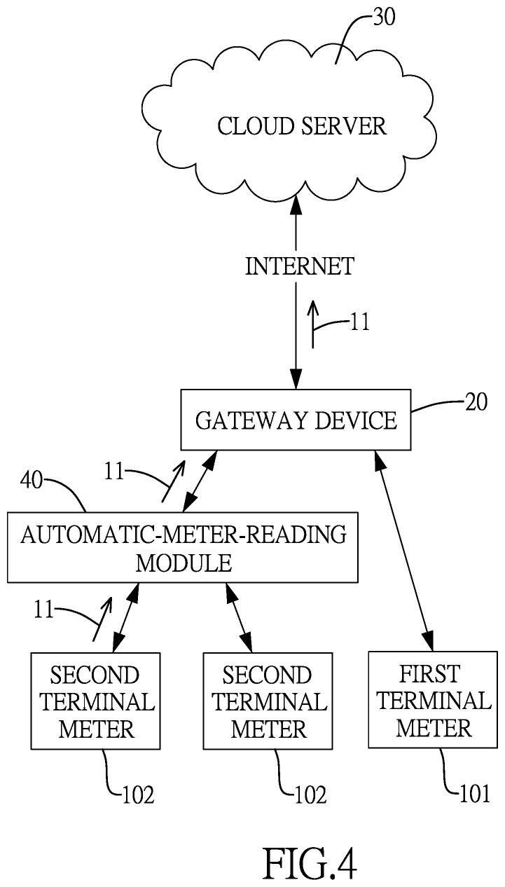

With reference to FIG. 1 and FIG. 2, the gateway device 20 is directly connected to the at least one terminal meter 10 having communication function. In another embodiment, the gateway device 20 is indirectly connected to the at least one terminal meter 10 having no communication function. For example, with reference to FIG. 3, an automatic-meter-reading (AMR) module 40 may be connected between the gateway device 20 and the at least one terminal meter 10 having no communication function, such that the gateway device 20 is indirectly connected to the at least one terminal meter 10 via the automatic-meter-reading module 40. The automatic-meter-reading module 40 may be connected to the gateway device 20 through RS-485 connection, but not limited to the RS-485 connection. The automatic-meter-reading module 40 may be directly connected to the at least one terminal meter 10 that has no communication function. In addition, with reference to FIG. 4, the at least one terminal meter may comprise at least one first terminal meter 101 having communication function and at least one second terminal meter 102 having no communication function. The gateway device 20 is directly connected to the at least one first terminal meter 101. The gateway device 20 is indirectly connected to the at least one second terminal meter 102 via the automatic-meter-reading module 40. Hence, the gateway device 20 interfaces with both terminal meter with communication capability and the automatic-meter-reading module 40. For example, the first terminal meter 101 may be a digital power meter. The second terminal meter 102 may be a digital water meter.

Each one of the terminal meters 10 is adapted to output a measurement value 11 in real time. The terminal meter 10 with communication capability may transmit the measurement value 11 to the gateway device 20 directly. For the terminal meter having no communication function, the automatic-meter-reading module 40 brings into play to automatically collect the measurement values of such terminal meter that is directly connected to the automatic-meter-reading module 40 and relays the measurement values to the gateway device 20, such that the gateway device 20 may receive and further transmit the measurement values. Hence, the automatic-meter-reading module 40 becomes an alternative adapted to interface between the gateway device 20 and the terminal meter without communication capability. Because the automatic-meter-reading module 40 collects the measurement values from the terminal meters directly connected thereto on behalf of the gateway device 20 and transmits all the collected measurement values to the gateway device 20, the workload of the gateway device 20 is thus relieved, such that the communication overhead of the gateway device 20 is reduced. In addition, owing to the reduced communication overhead of the gateway device 20 arising from the use of the automatic-meter-reading module 40, less network bandwidth used for the remote metering while not compromising the latency issue in communication brings forth cost-effective benefits to the remote metering system in a home environment.

For example, an apartment may have multiple rooms for rent. Each room may correspond to one terminal meter 10 or more than one terminal meter 10. For example, the terminal meter 10 may be, but not limited to, a digital power meter connected to power lines of the room, such that the measurement value 11 reflects power consumption of the room. Further, the terminal meter 10 may be a digital water meter mounted on water pipes or a digital gas meter mounted on gas pipes to output the measurement value 11 for measuring water consumption or gas consumption in the room.

A switching apparatus may be applied to the room. For example, the switching apparatus may be a relay or an electric valve device. The relay may be connected to power lines of the room. When the relay is turned on, electricity can pass the relay to be provided to the room. When the relay is turned off, electricity cannot pass the relay and fail to be provided to the room. Similarly, the electric valve device (such as a solenoid valve with an actuator) may be mounted on water pipes or gas pipes of the room. When the electric valve device is turned on, water or gas can pass the electric valve device to be provided to the room. When the electric valve device is turned off, water or gas cannot pass the electric valve device and fail to be provided to the room.

There are several methods for the renter to have a permission to use electricity, water, or gas of the room. For example, in an embodiment of the present invention, a controller, such as a card reader, may be installed in the room and connected to the relay or the electric valve device. The relay or the electric valve device is controlled by the card reader. The renter may get a stored-value card as the permission from the landlord. Hence, the renter may insert the stored-value card into the card reader. The card reader turns on the relay or the electric valve device when the card reader determines that the stored-value card is valid, such that the electricity, water, or gas is provided to the room. In another embodiment, the controller may have a QR-code pattern. The renter may stand near the controller and operate a smart phone. The smart phone executes an application (APP) to scan the QR-code pattern of the controller and wirelessly communicates with the controller. For example, the smart phone may communicate with the controller via short-range wireless communication, such as Bluetooth. When the APP determines that the QR-code pattern is valid, the renter would have the permission. Therefore, the renter may operate the smart phone to transmit a control command to the controller. The controller turns on or turns off the relay or the electric valve device according to the control command.

With reference to FIGS. 1-4, the cloud server 30 is connected to the gateway device(s) 20 via Internet. In an embodiment, the gateway device(s) 20 may be connected to a router (not shown in the figures) via Ethernet. The router may be connected to the cloud server 30 via Internet. The gateway device(s) 20 transmits the measurement values 11 to the cloud server 30, such that the cloud server 30 may receive the measurement values 11 from the gateway device(s) 20 and store the measurement values 11 in a computer-readable storage medium (such as a hard disk drive) of the cloud server 30 in real time. Further, the cloud server 30 may automatically produce an analysis report according to the measurement values 11.

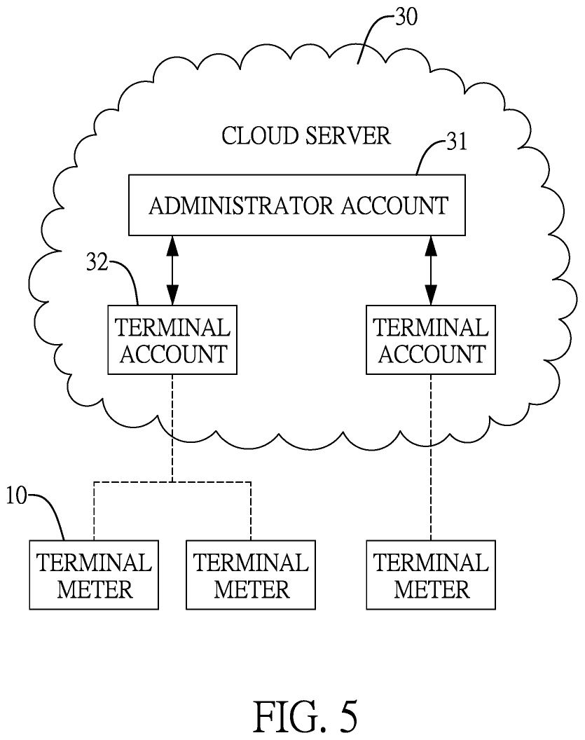

With reference to FIG. 5, the cloud server 30 may provide an administrator account 31 and at least one terminal account 32 monitored by the administrator account 31. FIG. 5 shows two terminal accounts 32 as an example. Each terminal account 32 may correspond to at least one of the multiple terminal meters 10. Hence, the measurement values 11 from the terminal meters 10 may be transmitted to the cloud server 30 and stored in the corresponding terminal account 32. The administrator account 31 is adapted to monitor the measurement values 11 of the at least one terminal account 32.

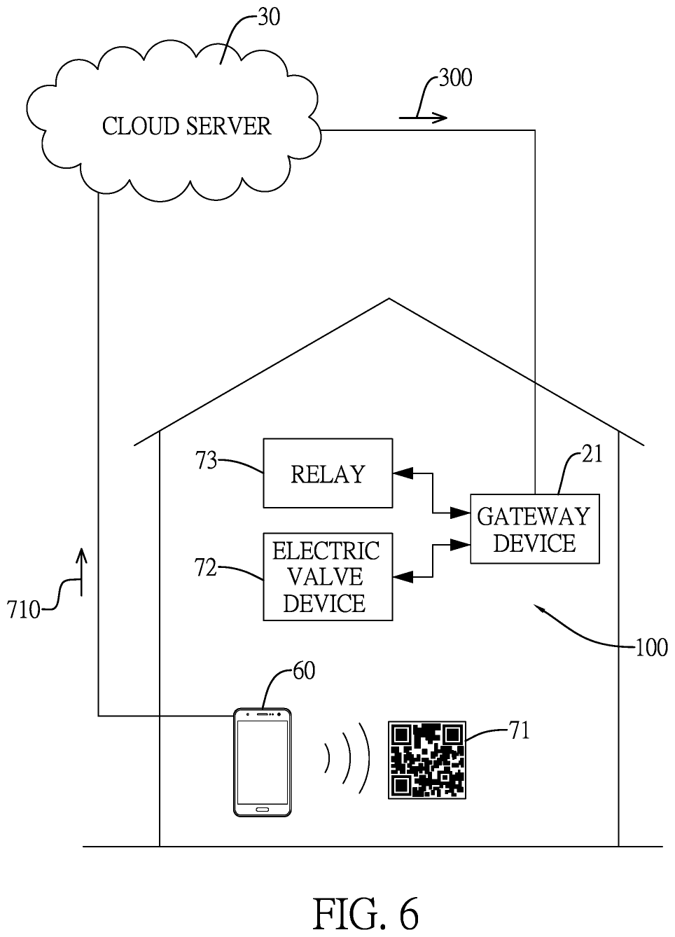

Besides, the system of the present invention may further comprise at least one switching apparatus. The cloud server 30 may remotely control the switching apparatus. As mentioned above, the switching apparatus may be a relay or an electric valve device. For example, in an embodiment of the present invention, with reference to FIG. 6, a QR-code pattern 71, the electric valve device 72 (such as a solenoid valve with an actuator), and the relay 73 are applied to a room 100. The QR-code pattern 71 may be printed on a plate or a paper. The electric valve device 72 and the relay 73 may be connected to the cloud sever 30 via another gateway device 21. With reference to FIG. 5 and FIG. 6, the QR-code pattern 71 has ID (identification) information corresponding to one terminal account 32 of the cloud server 30. A user may operate a user device 60 to execute an application (APP) to communicate with the cloud server 30 and scan the QR-code pattern 71. The APP may read and analyze the QR-code pattern 71 to obtain the ID information 710. Afterwards, the user device 60 transmits the ID information 710 to the cloud server 30.

When the cloud server 30 receives the ID information 710, the cloud server 30 determines whether the ID information 710 is valid. For example, the ID information 710 would be valid when the ID information 710 is in accordance with one terminal account 32. As a result, when the ID information 710 is valid, the cloud server 30 may transmit control commands 300 to the gateway device 21 to control the electric valve device 72 or the relay 73. The electric valve device 72 or the relay 73 of the room 100 would be turned on or turned off according to the control commands 300. On the contrary, when the ID information is invalid, the electric valve device 72 or the relay 73 of the room 100 would be turned off by the cloud server 30. Thus, the purpose of remotely controlling the electric valve device 72 or the relay 73 by the cloud server 30 is achieved.

For example, a landlord may create the administrator account 31 and the at least one terminal account 32 in the cloud server 30. The landlord may operate a user device to communicate with the cloud server 30, wherein the user device may be, but not limited to, a personal computer, a notebook computer, or a smart device (such as a smart phone or a tablet). The user device displays a user interface (UI) for being operated by a user. The landlord has the authorization to login the administrator account 31 and the at least one terminal account 32 and review information stored in the administrator account 31 and the at least one terminal account 32. A renter may operate a user device as mentioned above to communicate with the cloud server 30. The renter is authorized by the landlord to use one terminal account 32, such that the renter may login the terminal account 32 and review information stored in the terminal account 32.

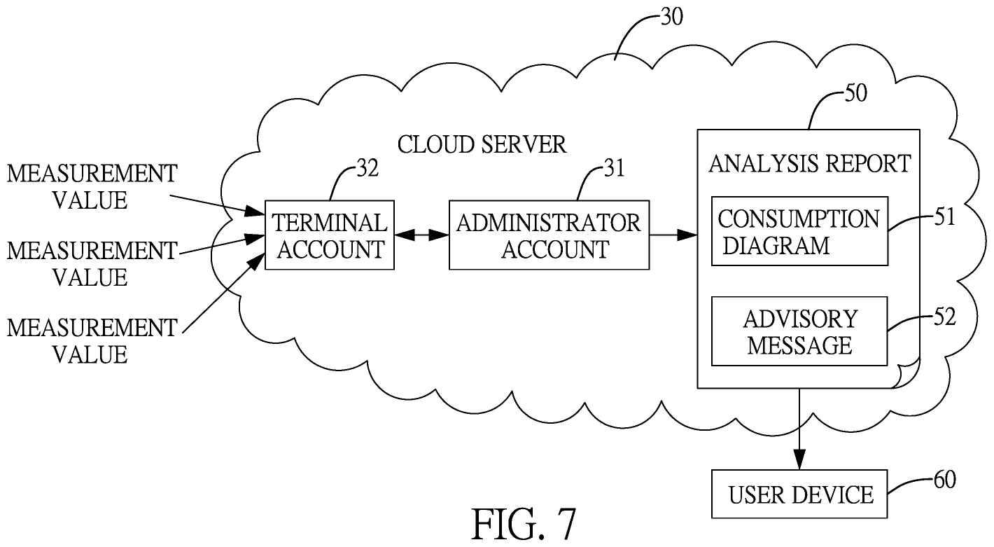

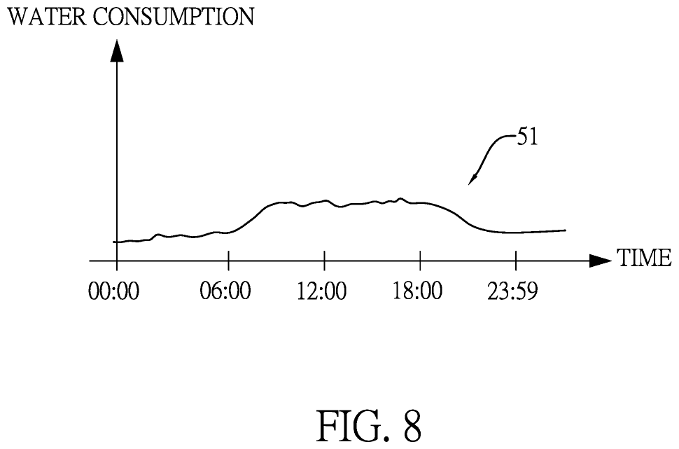

With reference to FIG. 7, the analysis report 50 is produced by and stored in the cloud server 30 in accordance with the measurement values stored in the terminal account 32. For example, the analysis report 50 may be a billing report and is periodically produced according to the measurement values and price (such as electricity price or water price). In addition, the analysis report may further provide a consumption diagram that reflects utility usage behavior, such as electricity, water, and/or gas usage behavior, of the corresponding room. For example, FIG. 8 shows an example of the consumption diagram 51 of water usage behavior during a day in a room. The consumption diagram 51 may be shown in the analysis report 50. Hence, the landlord and the renter may respectively use their user devices 60 to communicate with the cloud server 30, login in the administrator account 31 and the terminal account 32, and review the analysis report 50 to understand water usage behavior in the day.

Therefore, the information reviewed by the renter and the landlord is same, so disputes between the landlord and the renter may be avoided. Besides, with reference to FIG. 7, the analysis report 50 may provide an advisory message 52. The advisory message 52 may be pre-established in the cloud server 30 or updated from websites in real time. For example, electricity price varies in different time periods of a day. The advisory message 52 may be a text to notify the user that the electricity price during which time period is lower and during which time period is higher. Therefore, the user may accordingly turn off some electric appliances during the time with higher electricity price, such that electricity usage may be effectively economized.

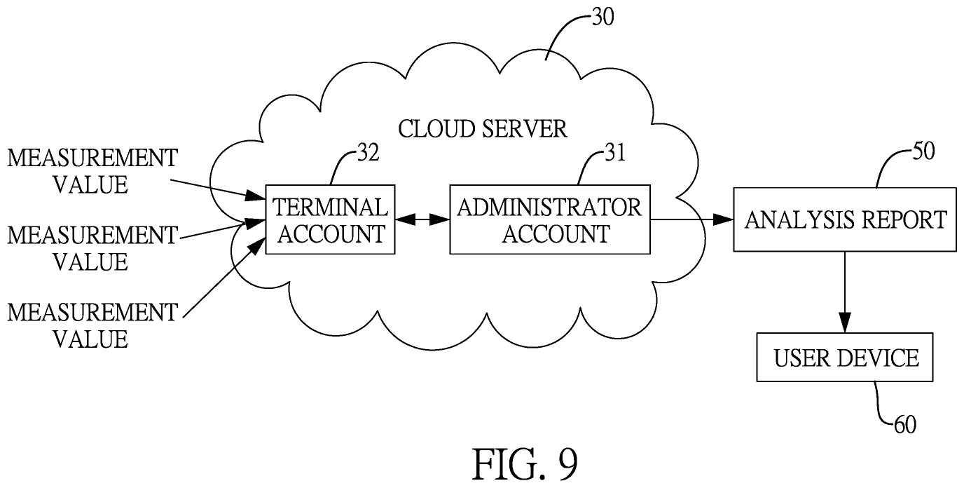

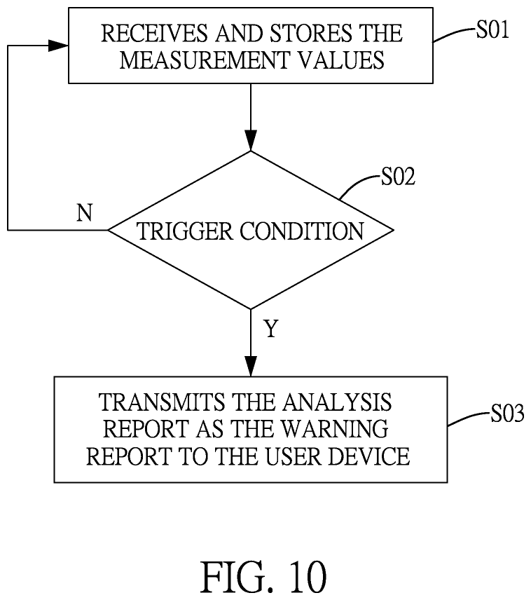

In another embodiment, the analysis report 50 may be a warning report. With reference to FIG. 9 and FIG. 10, the cloud server 30 receives and stores the measurement values (STEP S01). The cloud server determines whether a trigger condition occurs (STEP S02). When the cloud server 30 determines that a trigger condition occurs, the cloud server 30 transmits the analysis report 50 as the warning report to the user device 60 by application (APP), e-mail, short message service (SMS), or push notification service (STEP S03). For example, contact information and/or trigger condition are pre-established and stored in the cloud server 30 by the renter or the landlord. The contact information may be, but not limited to, e-mail addresses or phone numbers.

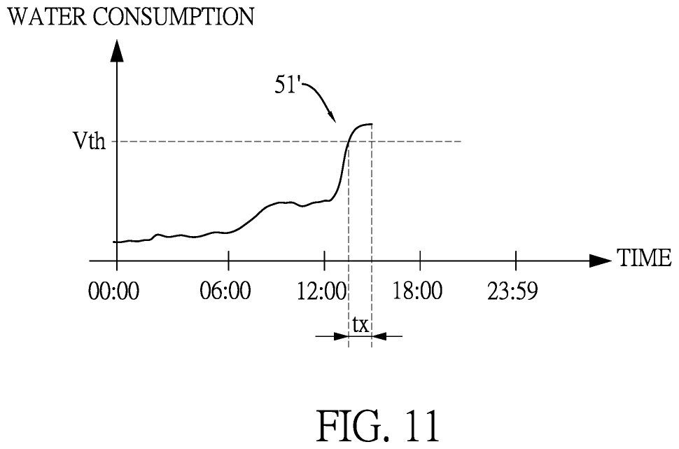

For example, the trigger condition may be that a consumption status is higher or lower than a pre-determined threshold value for a pre-determined continuous time. With reference to FIG. 11, the real-time consumption diagram 51′ reflecting a water consumption status is rapidly increased after 12:00, which means a water pipe is broken. The consumption diagram 51′ is higher than the pre-determined threshold value (Vth) for the pre-determined continuous time (tx). Thus, the cloud server 30 determines that the trigger condition occurs and accordingly transmits the analysis report 50 as the warning report to the user device 60 immediately. As a result, when a user or a technician reviews the warning report, the user or the technician may check water pipes to find out the broken water pipe and fix it to stop water wasting.

What is claimed is:

1. A cloud metering and analyzing system comprising:
an automatic-meter-reading module directly connected to at least one terminal meter having no communication function to collect at least one measurement value from the at least one terminal meter, wherein the at least one terminal meter is at least one digital meter;
at least one gateway device connected to the automatic-meter-reading module to receive and transmit the at least one measurement value; and
a cloud server connected to the at least one gateway device to receive and store the at least one measurement value from the at least one gateway device in real time and automatically produce an analysis report according to the at least one measurement value.

2. The cloud metering and analyzing system as claimed in claim 1, wherein the at least one gateway device is further directly connected to at least one terminal meter having communication function, such that the at least one gateway device interfaces with both terminal meter having communication function and the automatic-meter-reading module.

3. The cloud metering and analyzing system as claimed in claim 1, wherein the cloud server transmits the analysis report to a user device according to contact information pre-established and stored in the cloud server.

4. The cloud metering and analyzing system as claimed in claim 2, wherein the cloud server transmits the analysis report to a user device according to contact information pre-established and stored in the cloud server.

5. The cloud metering and analyzing system as claimed in claim 3, wherein
the cloud server determines whether a trigger condition occurs;
when the cloud server determines that the trigger condition occurs, the cloud server transmits the analysis report as the warning report to the user device.

6. The cloud metering and analyzing system as claimed in claim 4, wherein
the cloud server determines whether a trigger condition occurs;
when the cloud server determines that the trigger condition occurs, the cloud server transmits the analysis report as the warning report to the user device.

7. The cloud metering and analyzing system as claimed in claim 5, wherein the trigger condition is that a consumption status is higher or lower than a pre-determined threshold value for a pre-determined continuous time.

8. The cloud metering and analyzing system as claimed in claim 6, wherein the trigger condition is that a consumption status is higher or lower than a pre-determined threshold value for a pre-determined continuous time.

9. The cloud metering and analyzing system as claimed in claim 1 further comprising at least one switching apparatus connected to the cloud server and remotely controlled by the cloud server.

10. The cloud metering and analyzing system as claimed in claim 2 further comprising at least one switching apparatus connected to the cloud server and remotely controlled by the cloud server.

11. The cloud metering and analyzing system as claimed in claim 3 further comprising at least one switching apparatus connected to the cloud server and remotely controlled by the cloud server.

12. The cloud metering and analyzing system as claimed in claim 4 further comprising at least one switching apparatus connected to the cloud server and remotely controlled by the cloud server.

13. The cloud metering and analyzing system as claimed in claim 5 further comprising at least one switching apparatus connected to the cloud server and remotely controlled by the cloud server.

14. The cloud metering and analyzing system as claimed in claim 6 further comprising at least one switching apparatus connected to the cloud server and remotely controlled by the cloud server.

15. The cloud metering and analyzing system as claimed in claim 7 further comprising at least one switching apparatus connected to the cloud server and remotely controlled by the cloud server.

16. The cloud metering and analyzing system as claimed in claim 8 further comprising at least one switching apparatus connected to the cloud server and remotely controlled by the cloud server.
